(19) United States
(12) Patent Application Publication
(10) Pub. No.: US 2026/0086277 A1
(43) Pub. Date: Mar. 26, 2026

(54) OPTICAL ELEMENT AND DISPLAY DEVICE

(71) Applicant: Sharp Display Technology Corporation, Kameyama City (JP)

(72) Inventors: Jianeng XU, Kameyama City (JP); Yuichi KAWAHIRA, Kameyama City (JP); Masahiro HASEGAWA, Kameyama City (JP); Ryosuke SAIGUSA, Kameyama City (JP); Takeshi OYAMA, Kameyama City (JP); Akira SAKAI, Kameyama City (JP)

(21) Appl. No.: 19/338,079

(22) Filed: Sep. 24, 2025

(30) Foreign Application Priority Data
Sep. 25, 2024 (JP) 2024-166316

(51) Int. Cl. G02B 5/30; G02F 1/1335; G02F 1/13363

(52) U.S. Cl. CPC G02B 5/3083; G02F 1/133536; G02F 1/133638

(57) ABSTRACT

The optical element includes, in the following order: a first polarizer; a first retardation layer containing first anisotropic molecules; a second polarizer; a second retardation layer containing second anisotropic molecules; and a third polarizer. In a plan view, absorption or reflection axes of the first, second, and third polarizers are parallel. In a plan view, slow axes of the first and second retardation layers are parallel. The absorption or reflection axis of the first polarizer is perpendicular to the slow axis of the first retardation layer. A tilt angle of the first anisotropic molecules is constant in a thickness direction of the first retardation layer. A tilt angle of the second anisotropic molecules is constant in a thickness direction of the second retardation layer. In a plan view, the alignment azimuth of the first anisotropic molecules and the alignment azimuth of the second anisotropic molecules are oriented in opposite directions.

### CROSS-REFERENCE TO RELATED APPLICATIONS

The present application claims priority under 35 U.S.C. § 119 to Japanese Patent Application No. 2024-166316 filed on Sep. 25, 2024, the contents of which are incorporated herein by reference in their entirety.

### BACKGROUND OF THE INVENTION

### Field of the Invention

The following disclosure relates to optical elements and display devices including the optical element.

### Description of Related Art

Various display devices such as liquid crystal display devices and organic electroluminescent (EL) display devices have been widely used as devices that display images (moving images and still images). Optical elements are sometimes used in such display devices for the purpose of improving the viewability. Further consideration has been given to placing a transmissive optical element adjacent to the front surface of a liquid crystal panel.

For example, WO 2017/110216 discloses an optical element that is a transmissive optical element including a polarizing plate and at least one tilt-alignment retardation film in the stated order from a viewing side, wherein (i) an absorption axis of the polarizing plate and a slow axis of the tilt-alignment retardation film are within the range of +15 degrees to +55 degrees and −15 degrees to −55 degrees, and (ii) the tilt-alignment retardation film introduces an in-plane retardation of from 110 nm to 240 nm and the average tilt angle γ relative to a plane of the film is from 22 degrees to 55 degrees.

### SUMMARY

(1) One embodiment of the present invention is directed to an optical element including, in the following order: a first polarizer; a first retardation layer containing first anisotropic molecules; a second polarizer; a second retardation layer containing second anisotropic molecules; and a third polarizer, wherein in a plan view, an absorption axis or reflection axis of the first polarizer, an absorption axis or reflection axis of the second polarizer, and an absorption axis or reflection axis of the third polarizer are parallel to one another, in a plan view, a slow axis of the first retardation layer and a slow axis of the second retardation layer are parallel to each other, the absorption axis or reflection axis of the first polarizer is perpendicular to the slow axis of the first retardation layer, a tilt angle of the first anisotropic molecules is constant in a thickness direction of the first retardation layer, a tilt angle of the second anisotropic molecules is constant in a thickness direction of the second retardation layer, an alignment azimuth of the first anisotropic molecules is defined as an azimuth obtained by projecting a direction along long axes of the first anisotropic molecules from a side of the first retardation layer closer to the second polarizer toward a side of the first retardation layer closer to the first polarizer onto a surface of the first retardation layer adjacent to the first polarizer, an alignment azimuth of the second anisotropic molecules is defined as an azimuth obtained by projecting a direction along long axes of the second anisotropic molecules from a side of the second retardation layer closer to the third polarizer toward a side of the second retardation layer closer to the second polarizer onto a surface of the second retardation layer adjacent to the second polarizer, and in a plan view, the alignment azimuth of the first anisotropic molecules and the alignment azimuth of the second anisotropic molecules are oriented in directions opposite to each other.
(2) In an embodiment of the present invention, the optical element includes the structure (1), and a negative C plate is disposed at least one of between the first polarizer and the first retardation layer and between the second polarizer and the second retardation layer.
(3) In an embodiment of the present invention, the optical element includes the structure (1), and negative C plates are disposed, with one negative C plate positioned between the first polarizer and the first retardation layer and another negative C plate positioned between the second polarizer and the second retardation layer.
(4) In an embodiment of the present invention, the optical element includes the structure (2) or (3), and a retardation of the negative C plate in a thickness direction is 250 nm or more and 320 nm or less.
(5) In an embodiment of the present invention, the optical element includes any one of the structures (1) to (4), and a tilt angle of the first anisotropic molecules is substantially the same as a tilt angle of the second anisotropic molecules.
(6) In an embodiment of the present invention, the optical element includes any one of the structures (1) to (5), the first polarizer is an absorptive polarizer or a laminate of an absorptive polarizer and a reflective polarizer, the second polarizer is an absorptive polarizer or a reflective polarizer, and the third polarizer is a reflective polarizer or a laminate of an absorptive polarizer and a reflective polarizer.
(7) Another embodiment of the present invention is directed to a display device including, in the following order: a liquid crystal panel; the optical element including any one of the structures (1) to (6); and a backlight, the optical element being disposed with the first polarizer being adjacent to the liquid crystal panel.

The present disclosure can provide an optical element with a simple structure that can reduce or prevent coloring during observation from an oblique direction while reducing or preventing light leakage in oblique directions at azimuths corresponding to the top and bottom positions, and a display device including the optical element.

### BRIEF DESCRIPTION OF THE DRAWINGS

FIG. 1 illustrates a polar angle and azimuthal angles.

FIG. 2 is a schematic cross-sectional view of an optical element of Embodiment 1.

FIG. 3 is an exploded plan view illustrating slow axes of the retardation layers and the alignment azimuths of anisotropic molecules.

FIG. 4 shows axis azimuths of components of the optical element of Embodiment 1.

FIG. 5 is a schematic cross-sectional view of an optical element of Embodiment 2.

FIG. 6 is a schematic cross-sectional view of an optical element of Embodiment 3.

FIG. 7 is a schematic cross-sectional view of a display device of Embodiment 4.

FIG. 8 is a perspective view of an example of a prism sheet included in a backlight.

FIG. 9 is a schematic cross-sectional view of an optical element of Comparative Example 1.

FIG. 10 shows axis azimuths of components of the optical element of Comparative Example 1.

FIG. 11 shows simulation results showing the viewing angle in terms of transmittance and coloring of the optical element of Comparative Example 1.

FIG. 12 is a graph showing the normalized transmittance of the optical element of Comparative Example 1, measured at azimuthal angles from 0° to 360° and a polar angle of 60°.

FIG. 13 is a schematic cross-sectional view of an optical element of Comparative Example 2.

FIG. 14 shows simulation results showing the viewing angle in terms of transmittance and coloring of the optical element of Comparative Example 2.

FIG. 15 is a graph showing the normalized transmittance of the optical element of Comparative Example 2, measured at azimuthal angles from 0° to 360° and a polar angle of 60°.

FIG. 16 shows simulation results showing the viewing angle in terms of transmittance and coloring of an optical element of Example 1.

FIG. 17 is a graph showing the normalized transmittance of the optical element of Example 1, measured at azimuthal angles from 0° to 360° and a polar angle of 60°.

FIG. 18 shows simulation results showing the viewing angle in terms of transmittance and coloring of an optical element of Example 2.

FIG. 19 is a graph showing the normalized transmittance of the optical element of Example 2, measured at azimuthal angles from 0° to 360° and a polar angle of 60°.

FIG. 20 shows simulation results showing the viewing angle in terms of transmittance and coloring of an optical element of Example 3.

FIG. 21 is a graph showing the normalized transmittance of the optical element of Example 3, measured at azimuthal angles from 0° to 360° and a polar angle of 60°.

FIG. 22 is a table summarizing the simulation results showing the viewing angles in terms of transmittance and coloring of the optical elements of Examples 4 to 8.

FIG. 23 is a graph showing the transmittance of an optical element measured at polar angles of 60° and 70° when the tilt angles of anisotropic molecules were varied.

FIG. 24 is a table summarizing the simulation results showing the viewing angles in terms of transmittance and coloring of the optical elements of Examples 3 and 8 to 12.

FIG. 25 is a graph showing the transmittance of an optical element measured at polar angles of 60° and 70° when the in-plane retardations of retardation layers were varied.

### DETAILED DESCRIPTION OF THE INVENTION

Liquid crystal display devices are roughly classified into reflective liquid crystal display devices and transmissive liquid crystal display devices depending on the method of transmitting light through the liquid crystal layer. Transmissive liquid crystal display devices include a backlight including a light source on or behind the back surface of a liquid crystal panel, and perform display by transmitting light emitted from the backlight through a liquid crystal layer. For example, when an optical element is overlaid on an in-vehicle display, it is desirable for the optical element to reduce or prevent light leakage in oblique directions at azimuths corresponding to the top and bottom positions and have high viewability at azimuths corresponding to the left and right positions. The studies made by the present inventors also show that an image may appear in an unintended color during observation of the optical element from an oblique direction, which leaves room for further improvement.

WO 2017/110216 includes consideration given to disposing a specific optical element on the observation surface side of the display device to reduce a decrease in viewability due to external light reflection. This document, however, does not mention any consideration on light-shielding performance at azimuths corresponding to the top and bottom positions and coloring during observation from an oblique direction.

In response to the above issues, an object of the present disclosure is to provide an optical element with a simple structure that can reduce or prevent coloring during observation from an oblique direction while reducing or preventing light leakage in oblique directions at azimuths corresponding to the top and bottom positions, and a display device including the optical element.

Hereinafter, embodiments of the present invention are described. The present invention is not limited to the contents of the embodiments. The design may be modified as appropriate within the range satisfying the configuration of the present invention. In the following description, components having the same or similar functions in different drawings are commonly provided with the same reference sign so as to appropriately avoid repetition of description. The structures in the present invention may be combined as appropriate without departing from the gist of the present invention.

### Definition of Terms

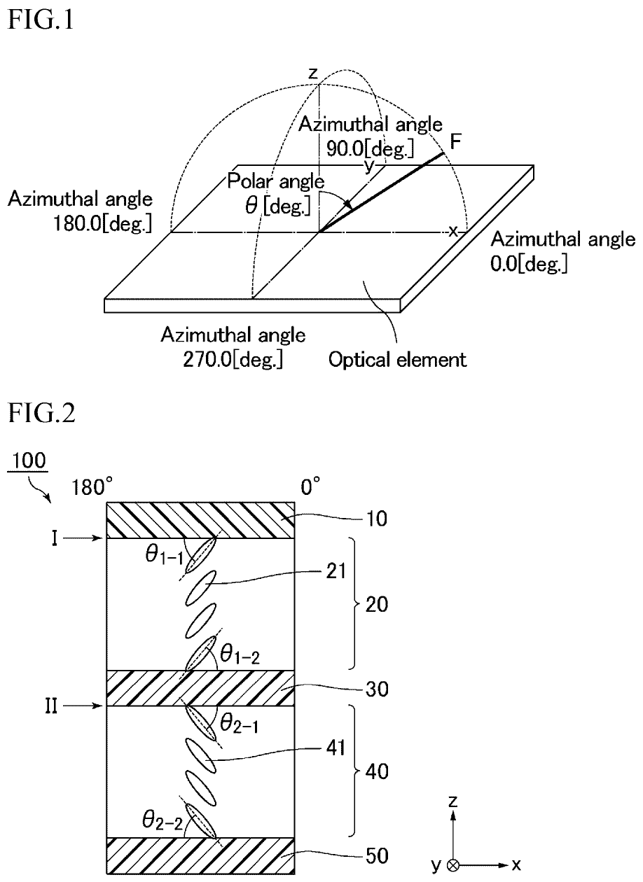

FIG. 1 shows a polar angle and azimuthal angles. The polar angle θ herein means, as shown in FIG. 1, an angle formed by the direction in question (e.g., measurement direction F) and a direction parallel to the normal of a main surface of an optical element. In other words, a direction parallel to the normal (z) of the main surface (xy plane) of the optical element corresponds to a polar angle of 0°. The direction parallel to the normal is also referred to as a normal direction. The “azimuth” herein means the direction in question in a view projected onto the main surface of the optical element and is expressed as an angle (also referred to as an azimuthal angle) formed with the reference azimuth (azimuthal angle of 0°). The reference azimuth is set, for example, to the right in the horizontal direction when the optical element is viewed from the observation surface side.

Herein, the expression that two axes (directions) are “parallel” means an angle (absolute value) formed by the two falls within the range of 0°±3°, preferably within the range of 0°±1°, more preferably within the range of 0°±0.5°, particularly preferably 0° (perfectly parallel). The expression that two axes (directions) are “perpendicular” to each other means that the angle (absolute value) formed by the two falls within the range of 90±3°, preferably within the range of 90°±1°, more preferably within the range of 90°±0.5°, particularly preferably 90° (perfectly perpendicular). Examples of the axes include the transmission axis and reflection axis of a polarizer and the slow axis of a retardation layer.

Herein, a birefringent layer provides, for example, a retardation (in-plane retardation) Re in the in-plane direction or a retardation Rth in the thickness direction in absolute value of 10 nm or more, preferably 20 nm or more. The term “birefringent layer” encompasses a retardation layer and a negative C plate. The retardation Re in the in-plane direction of the birefringent layer, the retardation Rth in the thickness direction of the birefringent layer, the NZ coefficient (biaxial parameter) of the birefringent layer are respectively represented by the formulas below wherein d represents the thickness of the birefringent layer, nx represents the refractive index in the x-axis direction, ny represents the refractive index in the y-axis direction, and nz represents the refractive index in the z-axis direction. ns refers to the larger of nx and ny, and nf refers to the smaller of nx and ny. The x-axis is set at azimuthal angle 0°-180°, the y-axis is set at azimuthal angle 90°-270°, and the z-axis is set perpendicular to the x-axis and the y-axis. Re, Rth, and NZ coefficient herein are introduced at 550 nm and measured at a temperature of 23° C., unless otherwise specified. The retardation refers to an in-plane retardation Re, unless otherwise specified.

$$R e = ( n s - nf ) \times d$$

$$Rth = \{ nz - ( nx + ny ) / 2 \} \times d$$

$$NZ = ( n s - nz ) / ( n s - nf )$$

The expression “azimuthal angle A°-B°” means a direction along an azimuthal angle of A° and an azimuthal angle of B° in a plan view. Herein, the azimuthal angle 0°-180° is also referred to as azimuths corresponding to the left and right positions, and the azimuthal angle 90°-270° is also referred to as azimuths corresponding to the top and bottom positions. An azimuthal angle of 90° is referred to the top direction, and an azimuthal angle of 270° is referred to as a bottom direction.

Herein, the observation surface side of the component in question means a side closer to the observer relative to the component, and the back surface side of the component in question means a side farther from the observer relative to the component, where the component in question is disposed to face the observer. Herein, a plan view refers to a state where the target is viewed from the observation surface side.

### Embodiment 1

FIG. 2 is a schematic cross-sectional view of the optical element of Embodiment 1. As shown in FIG. 2, an optical element 100 of Embodiment 1 includes, in the following order, a first polarizer 10, a first retardation layer 20, a second polarizer 30, a second retardation layer 40, and a third polarizer 50. The optical element 100 functions as an optical louver, and a configuration including the components from the first polarizer 10 to the third polarizer 50 is therefore referred to also as a polarizer louver. In the embodiments, the side of the optical element 100 where the first polarizer 10 is located is also referred to as the observation surface side, and the side where the third polarizer 50 is located is also referred to as the back surface side. However, the optical element 100 may be disposed such that the side where the first polarizer 10 is located serves as the back surface side and the side where the third polarizer 50 is located serves as the observation surface side.

### (Polarizer)

The first polarizer 10, the second polarizer 30, and the third polarizer 50 each have a function of filtering unpolarized light (natural light), partially polarized light, or polarized light into polarized light (linearly polarized light) vibrating only in a specific direction. These polarizers are also referred to as linearly polarizing plates. The first polarizer 10, the second polarizer 30, and the third polarizer 50 may each be an absorptive polarizer or a reflective polarizer. The absorptive polarizer has an absorption axis along which the polarizer absorbs light vibrating in a specific direction, and a transmission axis along which the polarizer transmits polarized light (linearly polarized light) vibrating in a direction perpendicular to the specific direction. The reflective polarizer has a reflection axis along which the polarizer reflects light vibrating in a specific direction and a transmission axis along which the polarizer transmits polarized light (linearly polarized light) vibrating in a direction perpendicular to the specific direction.

The first polarizer 10, the second polarizer 30, and the third polarizer 50 may each be an absorptive polarizer. With this configuration, the optical element 100 can absorb side lobe light when a backlight is disposed on or behind the back surface side of the optical element 100, so that light-shielding performance in oblique directions at azimuths corresponding to the top and bottom positions can be further improved.

The first polarizer 10 may be an absorptive polarizer and the third polarizer 50 may be a reflective polarizer. When the third polarizer 50 on the back surface side is a reflective polarizer and a backlight is disposed on or behind the back surface side of the optical element 100, light can be recycled by causing the third polarizer 50 to reflect the light from the backlight toward the backlight, and then causing a reflector of the backlight, for example, to emit the reflected light to the observation surface side again. This can increase the luminance in the normal direction during white display.

The first polarizer 10 may be an absorptive polarizer, a reflective polarizer, or a laminate of an absorptive polarizer and a reflective polarizer. The second polarizer 30 may be an absorptive polarizer or a reflective polarizer. The third polarizer 50 may be an absorptive polarizer, a reflective polarizer, or a laminate of an absorptive polarizer and a reflective polarizer. The polarizer disposed on the observation surface side is preferably an absorptive polarizer or a laminate of an absorptive polarizer and a reflective polarizer. The polarizer disposed on the back surface side is preferably a reflective polarizer or a laminate of an absorptive polarizer and a reflective polarizer. When the first polarizer 10 is a laminate of an absorptive polarizer and a reflective polarizer, the absorptive polarizer and the reflective polarizer are preferably stacked in this order from the observation surface side. When the third polarizer 50 is a laminate of an absorptive polarizer and a reflective polarizer, the absorptive polarizer and the reflective polarizer are preferably stacked in this order from the observation surface side. A reflective polarizer has an effect of increasing the luminance in the normal direction during white display, but has a lower degree of polarization than an absorptive polarizer. Thus, use of a reflective polarizer alone may decrease the contrast ratio of the polarizer louver. A laminate of an absorptive polarizer and a reflective polarizer is therefore used to increase the contrast ratio while improving the luminance in the normal direction. When an absorptive polarizer and a reflective polarizer are laminated, the transmission axis of the absorptive polarizer and the transmission axis of the reflective polarizer are parallel to each other.

More preferably, both the first polarizer 10 and the third polarizer 50 are laminates of an absorptive polarizer and a reflective polarizer. Still more preferably, the first polarizer 10 and the third polarizer 50 each include a reflective polarizer on the back surface side of the absorptive polarizer. With such polarizers, the luminance and the contrast ratio can be further increased in a display device in which a liquid crystal panel is disposed on the front surface side of the optical element and a backlight is disposed on or behind the back surface side of the optical element. When the third polarizer 50, which is located on the backlight side, is a laminate of an absorptive polarizer and a reflective polarizer, the polarizer can reflect emission light from the backlight toward the backlight more efficiently to increase the efficiency of recycling light. When the first polarizer 10, which is located on the liquid crystal panel side, is a laminate of an absorptive polarizer and a reflective polarizer, light incident from the backlight side can further be reflected toward the backlight to further increase the front luminance of the liquid crystal panel.

Examples of the absorptive polarizer include those including a polarizing layer obtained by adsorbing a dichroic anisotropic material such as an iodine complex on a polyvinyl alcohol (PVA) film and aligning the material. A protective film such as a triacetyl cellulose (TAC) film may be disposed on at least one of the observation surface side and the back surface side of the polarizing layer.

Examples of the reflective polarizer include a reflective polarizer obtained by uniaxially stretching a co-extruded film made of multiple types of resins (e.g., APCF available from Nitto Denko Corporation, DBEF available from 3M Company), and a reflective polarizer including periodic arrays of metal thin lines (i.e., wire grid polarizer).

### (Retardation Layer)

The first retardation layer 20 and the second retardation layer 40 each have a function of utilizing its birefringent material or the like to introduce a retardation between the perpendicular two polarized light components, thereby changing the state of incident polarized light.

As shown in FIG. 2, the first retardation layer 20 contains first anisotropic molecules 21 and the second retardation layer 40 contains second anisotropic molecules 41. The tilt angle of the first anisotropic molecules 21 is constant in the thickness direction of the first retardation layer 20. The tilt angle of the second anisotropic molecules 41 is constant in the thickness direction of the second retardation layer 40. In a plan view, the alignment azimuth of the first anisotropic molecules 21 and the alignment azimuth of the second anisotropic molecules 41 are oriented in directions opposite to each other. This can utilize a simple structure in which one retardation layer is disposed between the first polarizer 10 and the second polarizer 30 whose absorption axes or reflection axes are parallel to each other and one retardation layer is disposed between the second polarizer 30 and the third polarizer 50 whose absorption axes or reflection axes are parallel to each other, so as to reduce or prevent light leakage in oblique directions at azimuths corresponding to the top and bottom positions and coloring during observation from an oblique direction. The structure of the optical element of the present embodiment can be simpler than the structure including, for example, a stack of retardation layers disposed between a pair of polarizers, and is thus advantageous from perspectives such as the cost of stacking multiple retardation layers and the yield in mass production. The expression “the alignment azimuth of the first anisotropic molecules 21 and the alignment azimuth of the second anisotropic molecules 41 are oriented in directions opposite to each other in a plan view” means that the alignment azimuth of the second anisotropic molecules 41 relative to the alignment azimuth of the first anisotropic molecules 21 falls within the range of 180°±3°, preferably within the range of 180°±1°, more preferably within the range of 180°±0.5°, and is particularly preferably 180° (anti-parallel).

The tilt angle of the first anisotropic molecules 21 means the angle at which the long axes of the first anisotropic molecules 21 are inclined relative to a surface parallel to the surface (first surface I) of the first retardation layer 20 adjacent to the first polarizer 10 or the surface of the first retardation layer 20 adjacent to the second polarizer 30. The tilt angle of the second anisotropic molecules 41 means the angle at which the long axes of the second anisotropic molecules 41 are inclined relative to a surface parallel to the surface (second surface II) of the second retardation layer 40 adjacent to the second polarizer 30 or the surface of the second retardation layer 40 adjacent to the third polarizer 50. The tilt angle is defined to be 0° or greater and 90° or smaller.

When the tilt angle of the first anisotropic molecules 21 included in the first retardation layer 20 and located near the first polarizer 10 is denoted by θ₁₋₁, the tilt angle of the first anisotropic molecules 21 included in the first retardation layer 20 and located near the second polarizer 30 is denoted by θ₁₋₂, the tilt angle of the second anisotropic molecules 41 included in the second retardation layer 40 and located near the second polarizer 30 is denoted by θ₂₋₁, and the tilt angle of the second anisotropic molecules 41 included in the second retardation layer 40 and located near the third polarizer 50 is denoted by θ₂₋₂, the θ₁₋₁ and the θ₁₋₂ are equal to each other since the tilt angle of the first anisotropic molecules 21 is constant in the thickness direction of the first retardation layer 20. Additionally, the θ₂₋₁ and the θ₂₋₂ are equal to each other since the tilt angle of the second anisotropic molecules 41 is constant in the thickness direction of the second retardation layer 40.

Hereinbelow, the alignment azimuth of the anisotropic molecules is described. As shown in FIG. 2, the alignment azimuth of the first anisotropic molecules 21 is defined as an azimuth obtained by projecting a direction along long axes of the first anisotropic molecules 21 from a side of the first retardation layer 20 closer to the second polarizer 30 toward a side of the first retardation layer 20 closer to the first polarizer 10 onto a surface (first surface I in FIG. 2) of the first retardation layer 20 adjacent to the first polarizer 10. Additionally, the alignment azimuth of the second anisotropic molecules 41 is defined as an azimuth obtained by projecting a direction along long axes of the second anisotropic molecules 41 from a side of the second retardation layer 40 closer to the third polarizer 50 toward a side of the second retardation layer 40 closer to the second polarizer 30 onto a surface (second surface II in FIG. 2) of the second retardation layer 40 adjacent to the second polarizer 30. In other words, the alignment azimuth of anisotropic molecules in the embodiment means an azimuth obtained by projecting a direction along the optic axes (long axes) of anisotropic molecules from the back surface side toward the observation surface side onto the surface of a retardation layer. The alignment azimuth of anisotropic molecules means the average alignment azimuth of anisotropic molecules in each retardation layer.

The tilt angle of the first anisotropic molecules 21 and the tilt angle of the second anisotropic molecules 41 are preferably substantially the same. The expression that the tilt angles of the two sets of anisotropic molecules are substantially the same means that, in consideration of production tolerance, for example, the difference in tilt angle between the two sets of anisotropic molecules is preferably 1° or less, more preferably 0.5° or less, still more preferably 0°.

The difference in thickness between the first retardation layer and the second retardation layer is preferably 1 μm or less. More preferably, the thicknesses of these retardation layers are the same.

More preferably, when the right in the horizontal direction during observation of the optical element from the side where the first polarizer 10 is located is defined as an azimuthal angle of 0° and the angle is measured as positive in the counterclockwise direction from an azimuthal angle of 0° and as negative in the clockwise direction from an azimuthal angle of 0°, the alignment azimuth of the first anisotropic molecules 21 is 0°±3° and the alignment azimuth of the second anisotropic molecules 41 is 180°±3°, or the alignment azimuth of the first anisotropic molecules 21 is 180°±3° and the alignment azimuth of the second anisotropic molecules 41 is 0°±3°.

The first anisotropic molecules 21 are preferably not twist-aligned in the thickness direction of the first retardation layer 20, and the second anisotropic molecules 41 are preferably not twist-aligned in the thickness direction of the second retardation layer 40.

The in-plane retardation of each of the first retardation layer 20 and the second retardation layer 40 is preferably 180 nm or more and 250 nm or less. This structure can more effectively reduce or prevent oblique light at azimuths corresponding to the top and bottom positions. The in-plane retardation of each of the first retardation layer 20 and the second retardation layer 40 is more preferably 190 nm or more and 240 nm or less, still more preferably 200 nm or more and 230 nm or less.

Examples of the first anisotropic molecules 21 and the second anisotropic molecules 41 include those exhibiting positive wavelength dispersion where the birefringence (retardation) decreases as the wavelength becomes longer. Anisotropic molecules with positive wavelength dispersion make the transmittance in oblique directions of the optical element 100 different at different wavelengths, thus causing the optical element 100 to be perceived in multiple colors in mixture. In order to correct such coloring during observation from oblique directions, an additional retardation layer can possibly be disposed that contains anisotropic molecules exhibiting reverse wavelength dispersion where the birefringence increases as the wavelength becomes longer. However, such anisotropic molecules exhibiting ideal wavelength dispersion which allows color correction do not exist yet. In the present embodiment, two retardation layers in which the tilt angles of anisotropic molecules are constant are disposed such that the alignment azimuths of the anisotropic molecules in these retardation layers are oriented in directions opposite to each other. This configuration enables color cancellation during observation in an oblique direction across the optical element 100, thereby compensating for color shifts during observation of the display device from oblique directions.

The first anisotropic molecules 21 and the second anisotropic molecules 41 are molecules that cause the first retardation layer 20 and the second retardation layer 40 to exhibit birefringence, respectively. Specifically, the anisotropic molecules, when aligned in specific directions, exhibit anisotropy in light refractive index. Examples of the anisotropic molecules include polymerizable liquid crystals, cured products of polymerizable liquid crystals, and other liquid crystalline materials. The polymerizable liquid crystals are described in detail below.

The first retardation layer 20 and the second retardation layer 40 may each be, for example, a reactive mesogen layer (coating retardation layer) made of a cured product of polymerizable liquid crystals (reactive mesogens). The coating retardation layer can be formed, for example, by coating an alignment film having undergone an alignment treatment with polymerizable liquid crystals, followed by curing the polymerizable liquid crystals through baking, photoirradiation, or another method. The polymerized liquid crystals after the curing are aligned at the alignment azimuths of the alignment film defined by the alignment treatment to exhibit a retardation. The tilt angles of the first anisotropic molecules 21 and the second anisotropic molecules 41 can also be controlled by adjusting the type of the polymerizable liquid crystals, the firing conditions, the photoirradiation conditions (wavelength, intensity, irradiation angle of the irradiation light), and other conditions.

Examples of the alignment film used as a base of a coating retardation layer include those common in the field of liquid crystal panels, such as polyimide films. The alignment treatment for the alignment film can be rubbing, photoirradiation, or another treatment.

### (Axis Arrangement of Components)

FIG. 4 shows axis azimuths of components of the optical element of Embodiment 1. As shown in FIG. 4, in a plan view, the absorption axis or reflection axis (hereinbelow, referred to also as the first absorption axis or first reflection axis) of the first polarizer 10, the absorption axis or reflection axis (hereinbelow, referred to also as the second absorption axis or second reflection axis) of the second polarizer 30, and the absorption axis or reflection axis (hereinbelow, referred to as the third absorption axis or third reflection axis) of the third polarizer 50 are parallel to one another. In a plan view, since the absorption axis and transmission axis of an absorptive polarizer are perpendicular to each other and the reflection axis and transmission axis of a reflective polarizer are perpendicular to each other, the transmission axis of the first polarizer 10, the transmission axis of the second polarizer 30, and the transmission axis of the third polarizer 50 can be considered parallel to one another. In a plan view, the slow axis (hereinbelow, referred to as the first slow axis) of the first retardation layer 20 and the slow axis (hereinbelow, referred to as the second slow axis) of the second retardation layer 40 are parallel to each other, and the absorption axis or reflection axis of the first polarizer 10 is perpendicular to the slow axis of the first retardation layer 20. This structure can make the light-shielding range horizontally symmetrical while reducing or preventing light leakage in oblique directions at azimuths corresponding to the top and bottom positions, and can reduce or prevent coloring during observation from an oblique direction.

The first retardation layer 20 may be in contact with the first polarizer 10 and the second polarizer 30. The second retardation layer 40 may be in contact with the second polarizer 30 and the third polarizer 50.

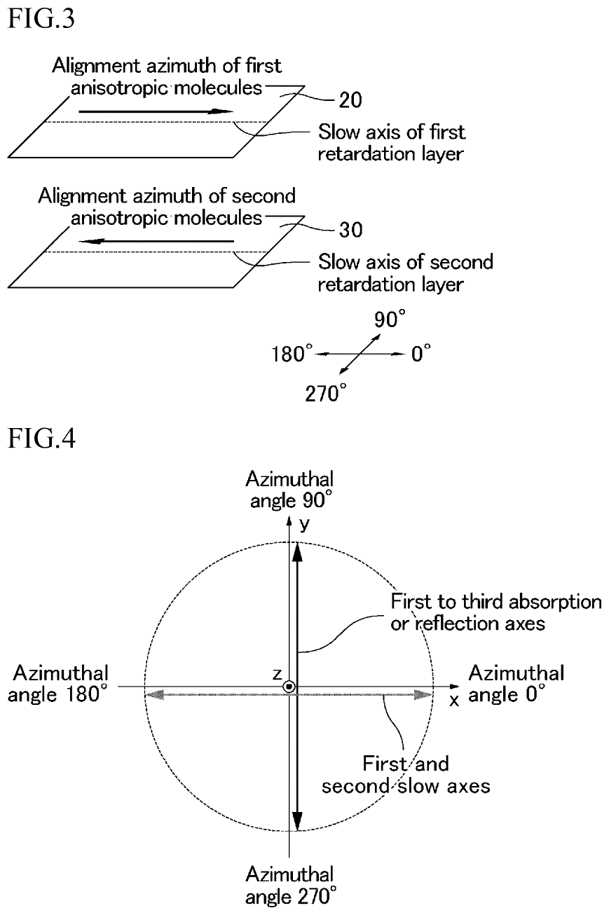

FIG. 3 is an exploded plan view illustrating slow axes of the retardation layers and the alignment azimuths of anisotropic molecules. As shown in FIG. 3, the azimuth of the slow axis of each retardation layer refers to an azimuth along the long axes of anisotropic molecules included in the retardation layer in a plan view, without considering the tilt angle of the anisotropic molecules. The slow axis of each retardation layer is parallel to the alignment azimuth of the anisotropic molecules, without considering the alignment azimuth of the anisotropic molecules. For example, when the alignment azimuth of the first anisotropic molecules 21 and the alignment azimuth of the second anisotropic molecules 41 are both set to an azimuthal angle of 180°, when the alignment azimuth of the first anisotropic molecules 21 and the alignment azimuth of the second anisotropic molecules 41 are both set to an azimuthal angle of 0°, and when one of the alignment azimuth of the first anisotropic molecules 21 and the alignment azimuth of the second anisotropic molecules 41 is set to an azimuthal angle of 180° and the other is at an azimuthal angle of 0°, the slow axis of the first retardation layer 20 and the slow axis of the second retardation layer 40 are parallel to each other.

The slow axis is measurable with a retardation measurement device (e.g., “Axoscan” available from Axometrics Inc.). Axoscan can measure a retardation, a slow axis, and a tilt angle of anisotropic molecules. Specifically, Axoscan measures a 4×4 matrix (Mueller matrix) containing 16 elements, which represents the polarization state of light, and then analyzes the measured values to determine the retardation, the slow axis, the tilt angle of the anisotropic molecules, and other properties.

When the first polarizer 10 is an absorptive polarizer, the absorption axis of the first polarizer 10 and the slow axis of the first retardation layer 20 are perpendicular to each other. When the first polarizer 10 is a laminate of an absorptive polarizer and a reflective polarizer, the absorption axis and reflection axis of the first polarizer 10 are perpendicular to the slow axis of the first retardation layer 20. Also, the transmission axis of the first polarizer 10 and the slow axis of the first retardation layer 20 are parallel to each other.

When the second polarizer 30 is an absorptive polarizer, the second absorption axis and the first absorption axis are parallel to each other. When the second polarizer 30 is a reflective polarizer, the second reflection axis and the first absorption axis are parallel to each other. When the third polarizer 50 is a reflective polarizer, the third reflection axis and the first absorption axis are parallel to each other. When the third polarizer 50 is a laminate of a reflective polarizer and an absorptive polarizer, the third reflection axis and the third absorption axis are parallel to the first absorption axis.

### (Polymerizable Liquid Crystals)

The polymerizable liquid crystals are suitably of a liquid crystalline polymer having a photoreactive group. Examples of the liquid crystalline polymer having a photoreactive group include polymers each having a structure with both a mesogen group and a photoreactive group in its side chain and having an acrylate, methacrylate, maleimide, N-phenylmaleimide, or siloxane, or another structure in its main chain. The mesogen group may be a biphenyl group, a terphenyl group, a naphthalene group, a phenylbenzoate group, an azobenzene group, or a derivative of any of these groups, which are often used as a mesogen component of a liquid crystalline polymer. The photoreactive group may be a cinnamoyl group, a chalcone group, a cinnamylidene group, a β-(2-phenyl) acryloyl group, a cinnamic acid group, or a derivative of any of these groups.

The liquid crystalline polymer may be a homopolymer consisting of a single repeat unit or may be a copolymer consisting of two or more repeat units different in side chain structure. The copolymer encompasses all of alternating copolymers, random copolymers, graft copolymers, and the like copolymers. In the copolymer above, a side chain of at least one repeat unit has a structure including both the mesogen group and the photoreactive group, and a side chain of any other repeat unit may not have the mesogen group or the photoreactive group.

Preferred specific examples of the liquid crystalline polymer include copolymerizable (meth)acrylic acid polymers having a repeat unit represented by the following general formula (I).

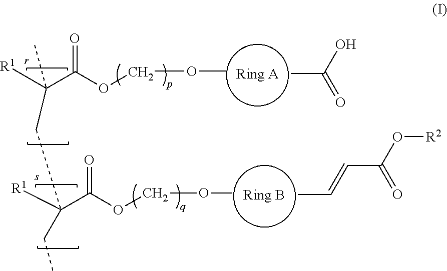

In the formula above, R¹ is a hydrogen atom or a methyl group; R² is an alkyl group, or a phenyl group substituted by a group selected from an alkyl group, an alkoxy group, a cyano group, and a halogen atom; ring A and ring B are each independently a group represented by any one of the following general formulas (M1) to (M5); p and q are each independently an integer of 1 to 12; and r and s are each a mole ratio of a monomer in a copolymer satisfying the relationships 0.65≤r≤0.95, 0.05≤s≤0.35, and r+s=1.

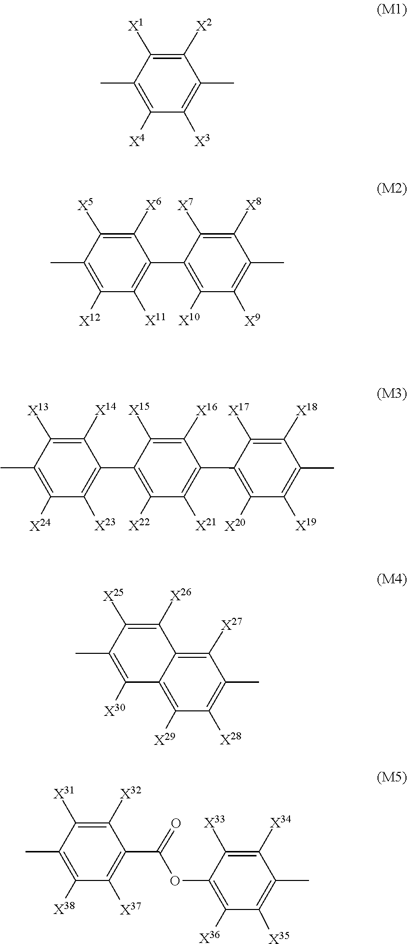

In the formulas above, X¹ to X³⁸ are each independently a hydrogen atom, an alkyl group, an alkoxy group, a halogen atom, or a cyano group.

Preferably, the liquid crystalline polymer is a copolymerizable (meth)acrylic acid polymer having a repeat unit represented by the following general formula (I-a).

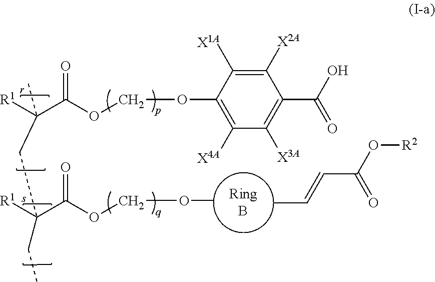

In the formula above, R¹ is a hydrogen atom or a methyl group; R² is an alkyl group, or a phenyl group substituted by a group selected from an alkyl group, an alkoxy group, a cyano group, and a halogen atom; X^{1A} to X^{4A} are each independently a hydrogen atom, an alkyl group, an alkoxy group, a halogen atom, or a cyano group; ring B is a group represented by the following general formula (M1a) or (M5a); p and q are each independently an integer of 1 to 12; and r and s are each a mole ratio of a monomer in a copolymer satisfying the relationships 0.65≤r≤0.95, 0.05≤s≤0.35, and r+s=1.

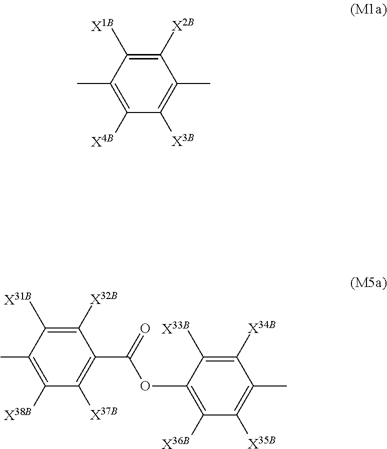

In the formulas above, X^{1B} to X^{4B} and X^{31B} to X^{38B} are each independently a hydrogen atom, an alkyl group, an alkoxy group, a halogen atom, or a cyano group.

In addition, the liquid crystalline polymer is more preferably a copolymerizable (meth)acrylic acid polymer having a repeat unit represented by the following general formula (I-b) or (I-c).

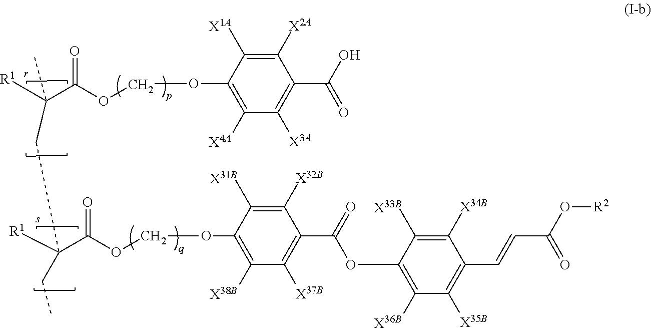

In the formula above, R¹ is a hydrogen atom or a methyl group; R² is an alkyl group, or a phenyl group substituted by a group selected from an alkyl group, an alkoxy group, a cyano group, and a halogen atom; X^{1A} to X^{4A} and X^{31B} to X^{38B} are each independently a hydrogen atom, an alkyl group, an alkoxy group, a halogen atom, or a cyano group; p and q are each independently an integer of 1 to 12; and r and s are each a mole ratio of a monomer in a copolymer satisfying the relationships 0.65≤r≤0.95, 0.05≤s≤0.35, and r+s=1.

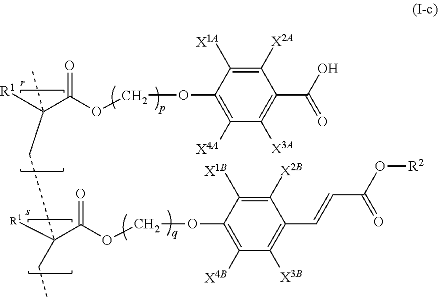

In the formula above, R¹ is a hydrogen atom or a methyl group; R² is an alkyl group, or a phenyl group substituted by a group selected from an alkyl group, an alkoxy group, a cyano group, and a halogen atom; X^{1A} to X^{4A} and X^{1B} to X^{4B} are each independently a hydrogen atom, an alkyl group, an alkoxy group, a halogen atom, or a cyano group; p and q are each independently an integer of 1 to 12; and r and s are each a mole ratio of a monomer in a copolymer satisfying the relationships 0.65≤r≤0.95, 0.05≤s≤0.35, and r+s=1.

In the general formula (I) (including the general formula (I-a), the general formula (I-b), and the general formula (I-c); the same holds for the following formulas), R¹ is preferably a methyl group; R² is preferably an alkyl group, or a phenyl group substituted by a group selected from an alkyl group, an alkoxy group, a cyano group, and a halogen atom, more preferably an alkyl group or a phenyl group substituted by an alkoxy group or a cyano group, particularly preferably an alkyl group or a phenyl group substituted by an alkoxy group.

X^{31B} to X^{38B} are each preferably a hydrogen atom or a halogen atom, and a case is most preferable where all of X^{31B} to X^{38B} are hydrogen atoms.

p and q are each preferably an integer of 3 to 9, more preferably an integer of 5 to 7, most preferably 6. r preferably falls within the range of 0.75≤r≤0.85, and is most preferably 0.8. Correspondingly, s preferably falls within the range naturally derived from the relationship r+s=1. In other words, s preferably falls within the range of 0.15≤s≤0.25, and is most preferably 0.2.

In the general formula (I-a), (I-b), or (I-c), X^{1A} to X^{4A} are each preferably a hydrogen atom or a halogen atom, and a case is particularly preferred where one of X^{1A} to X^{4A} is a halogen atom and the others are hydrogen atoms or where all of X^{1A} to X^{4A} are hydrogen atoms. In the general formula (I-b), X^{31B} to X^{38B} are each preferably a hydrogen atom or a halogen atom, and a case is most preferred where all of X^{31B} to X^{38B} are hydrogen atoms. In the general formula (I-c), X^{1B} to X^{4B} are each preferably a hydrogen atom or a halogen atom, and a case is most preferred where all of X^{1B} to X^{4B} are hydrogen atoms.

Examples of the alkyl group in R² or the alkyl group in the substituent of the phenyl group in R² include C1-C12 alkyl groups. Among these, preferred is a C1-C6 alkyl group, more preferred is a C1-C4 alkyl group, and most preferred is a methyl group. Examples of the alkoxy group in the substituent of the phenyl group in R² include C1-C12 alkoxy groups. Among these, preferred is a C1-C6 alkoxy group, more preferred is a C1-C4 alkoxy group, and most preferred is a methoxy group. Examples of the halogen group in the substituent of the phenyl group in R² include fluorine, chlorine, bromine, and iodine atoms, among which a fluorine atom is preferred.

Examples of the alkyl group in X¹ to X³⁸ include C1-C4 alkyl groups, among which a methyl group is most preferred. Examples of the alkoxy group in X¹ to X³⁸ include C1-C4 alkoxy groups, among which a methoxy group is most preferred. Examples of the halogen atom in X¹ to X³⁸ include fluorine, chlorine, bromine, and iodine atoms, among which a fluorine atom is preferred.

Herein, X^{1A} to X^{38A} indicate that X¹ to X³⁸, which are substituents on ring A or ring B, are those on ring A, and X^{1B} to X^{38B} indicate that X¹ to X³⁸ are those on ring B. Thus, description relating to X¹ to X³⁸ is directly applicable to X^{1A} to X^{38A} and X^{1B} to X^{38B}.

The liquid crystalline polymer can be dissolved in a solvent to be used as a retardation layer composition. The retardation layer composition may appropriately be mixed with a photopolymerization initiator, a surfactant, and a component usually included in a polymerizable composition that is polymerizable by light or heat.

Examples of the solvent used for the retardation layer composition include toluene, ethylbenzene, ethylene glycol monomethyl ether, ethylene glycol dimethyl ether, propylene glycol methyl ether, dibutyl ether, acetone, methyl ethyl ketone, ethanol, propanol, cyclohexane, cyclopentanone, methylcyclohexane, tetrahydrofuran, dioxane, cyclohexanone, n-hexane, ethyl acetate, butyl acetate, propylene glycol methyl ether acetate, methoxy butyl acetate, N-methyl pyrrolidone, and dimethylacetamide.

The photopolymerization initiator can be any known general photopolymerization initiator used to form a uniform film by application of a small amount of light. Specific examples thereof include azonitrile-based photopolymerization initiators such as 2,2′-azobisisobutyronitrile and 2,2′-azobis(2,4-dimethylvaleronitrile); α-amino ketone-based photopolymerization initiators such as IRGACURE 907 (available from Ciba Specialty Chemicals Inc.) and IRGACURE 369 (available from Ciba Specialty Chemicals Inc.); acetophenone-based photopolymerization initiators such as 4-phenoxydichloro acetophenone and 4-t-butyldichloroacetophenone; benzoin-based photopolymerization initiators such as benzoin and benzoin methyl ether; benzophenone-based photopolymerization initiators such as benzophenone and benzoylbenzoic acid; thioxanthone-based photopolymerization initiators such as 2-chlorothioxanthone and 2-methylthioxanthone; triazine-based photopolymerization initiators such as 2,4,6-trichloro-s-triazine and 2-phenyl-4,6-bis(trichloromethyl)-s-triazine; carbazole-based photopolymerization initiators, and imidazole-based photopolymerization initiators. Any of these photopolymerization initiators may be used alone or two or more of these may be used in combination.

The surfactant can be any surfactant generally used to form a uniform film. Specific examples thereof include anionic surfactants such as sodium lauryl sulfate and ammonium lauryl sulfate; nonionic surfactants such as polyethylene glycol monolaurate and sorbitan stearate; cationic surfactants such as stearyltrimethylammonium chloride and behenyltrimethylammonium chloride; amphoteric surfactants such as alkyl betaines including lauryl betaine and alkyl sulfobetaine, alkyl imidazoline, and sodium lauroyl sarcosinate; and surfactants such as BYK-361, BYK-306, BYK-307 (available from BYK Japan KK), Fluorad FC430 (available from Sumitomo 3M Limited), and Megaface F171 and R08 (available from DIC Corporation). Any of these surfactants may be used alone or two or more of these may be used in combination.

Polymerizable liquid crystals of a liquid crystalline polymer having a photoreactive group can be aligned by polarized light irradiation, for example. This allows formation of a coating retardation layer without an alignment film as a base material. As described above, formation of a coating retardation layer using a liquid crystalline polymer having a photoreactive group allows omission of an alignment film, thus thinning the optical element and simplifying the production steps.

### Embodiment 2

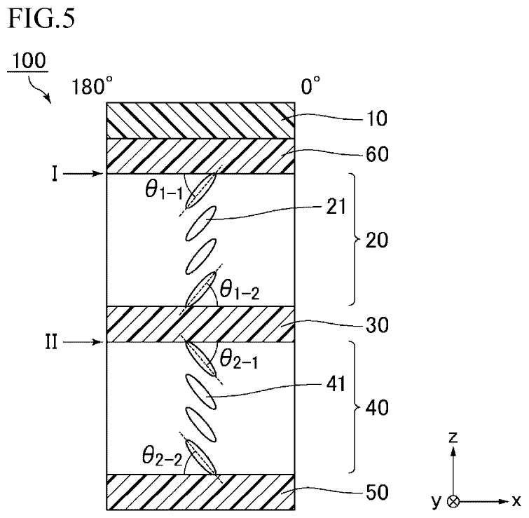

An optical element of Embodiment 2 includes a negative C plate disposed at least one of between the first polarizer 10 and the first retardation layer 20 and between the second polarizer 30 and the second retardation layer 40. FIG. 5 is a schematic cross-sectional view of the optical element of Embodiment 2. FIG. 5 shows a case where a negative C plate 60 is disposed between the first polarizer 10 and the first retardation layer 20. With the negative C plate 60 disposed at least one of between the first polarizer 10 and the first retardation layer 20 and between the second polarizer 30 and the second retardation layer 40, light leakage at azimuths corresponding to the top and bottom positions can be further reduced or prevented, thereby expanding the light-shielding range. In Embodiment 2, the slow axis of each retardation layer and the alignment azimuths of the anisotropic molecules are the same as shown in FIG. 3, and the axis azimuth of each component is the same as shown in FIG. 4. Thus, descriptions thereof are omitted.

The retardation of the negative C plate 60 in the thickness direction is preferably 250 nm or more and 320 nm or less. With the retardation in the thickness direction set to be 250 nm or more and 320 nm or less, the transmittance can be reduced and color shifts can be more effectively reduced or prevented, in oblique directions at azimuths corresponding to the top and bottom positions (for example, polar angle of 60° at an azimuthal angle of 90°). Herein, the negative C plate satisfies the conditions of nx=ny>nz and NZ=∞.

### Embodiment 3

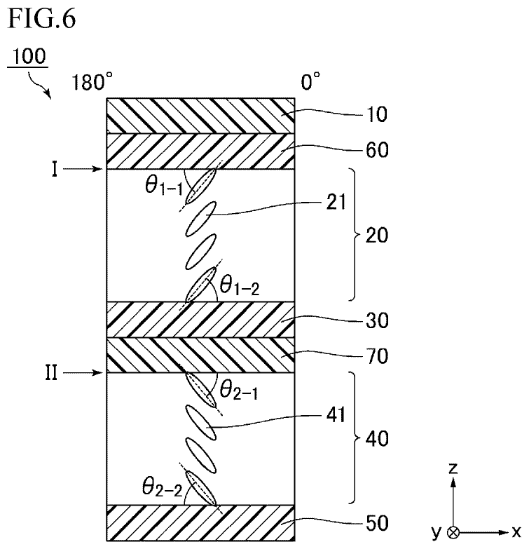

FIG. 6 is a schematic cross-sectional view of an optical element of Embodiment 3. The optical element of Embodiment 3 includes negative C plates, with one negative C plate disposed between the first polarizer 10 and the first retardation layer 20 and another negative C plate disposed between the second polarizer 30 and the second retardation layer 40. In Embodiment 2, the slow axis of each retardation layer and the alignment azimuths of the anisotropic molecules are the same as shown in FIG. 3 and the axis azimuth of each component is the same as shown in FIG. 4. Thus, descriptions thereof are omitted.

The negative C plate disposed between the first polarizer 10 and the first retardation layer 20 is referred to as a first negative C plate 60, and the negative C plate disposed between the second polarizer 30 and the second retardation layer 40 is referred to as a second negative C plate 70. With the first negative C plate 60 and the second negative C plate 70 disposed in this manner, the light-shielding range at azimuths corresponding to the top and bottom positions can be made wider than in Embodiment 2, and the light-shielding range can be made horizontally symmetrical.

The first negative C plate 60 and the second negative C plate 70 can each be the negative C plate described in Embodiment 2. The retardation of the first negative C plate 60 in the thickness direction and the retardation of the second negative C plate 70 in the thickness direction may be the same as or different from each other, but are preferably the same as each other.

### Embodiment 4

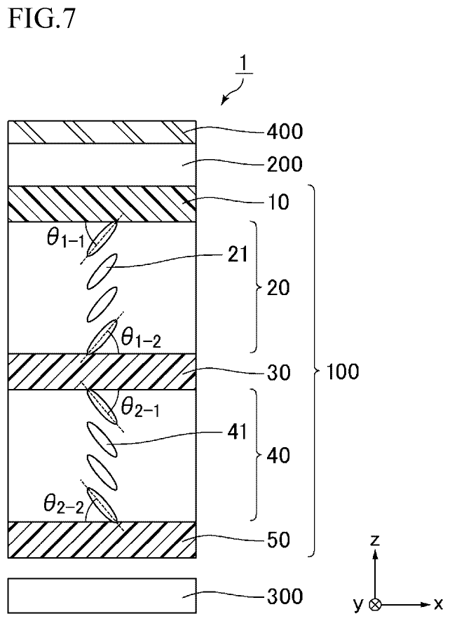

FIG. 7 is a schematic cross-sectional view of a display device of Embodiment 4. As shown in FIG. 7, a display device 1 of Embodiment 4 includes, in the following order: a liquid crystal panel 200; an optical element 100; and a backlight 300. The optical element 100 is disposed with the first polarizer 10 being adjacent to the liquid crystal panel 200.

The display device 1 may further include an observation surface side polarizer 400 on the observation surface side of the liquid crystal panel 200. The observation surface side polarizer 400 may be the absorptive polarizer or reflective polarizer described above, and is preferably the absorptive polarizer.

The absorption axis of the observation surface side polarizer 400 may be perpendicular or parallel to the absorption axis or reflection axis of the first polarizer 10. In order to achieve a high contrast ratio, the absorption axis of the observation surface side polarizer 400 is preferably perpendicular to the absorption axis or reflection axis of the first polarizer 10.

A liquid crystal panel usually has polarizers, with one polarizer disposed on the observation surface side and another polarizer disposed on the back surface side. The first polarizer 10 preferably functions also as a polarizer disposed on the back surface side of the liquid crystal panel. In other words, between the liquid crystal panel and the first polarizer 10, another polarizer is preferably not disposed. The first polarizer 10 may be, for example, attached to the back surface side of the liquid crystal panel 200 with a pressure-sensitive adhesive layer or the like. The optical element 100 may be the optical element of any one of Embodiments 1 to 3.

### (Liquid Crystal Panel)

The liquid crystal panel 200 may include a pair of substrates and a liquid crystal layer held between the pair of substrates. The pair of substrates may consist of a TFT substrate including switching elements such as thin film transistors (TFTs) and a counter substrate. Color filters may be included in the TFT substrate or in the counter substrate.

The counter substrate may include, for example, color filters and a black matrix which partitions the color filters. The TFT substrate may include gate lines and source lines crossing the gate lines and may have a structure in which TFTs are disposed at or near the intersections of the gate lines and the source lines and pixel electrodes electrically connected to the TFTs are disposed.

Examples of the liquid crystal panel include those in the vertical alignment (VA) mode, those in the fringe field switching (FFS) mode, those in the in-plane-switching (IPS) mode, and those in the twisted nematic (TN) mode.

In the VA mode, a counter electrode is disposed in the CF substrate and liquid crystal molecules in the liquid crystal layer may be aligned substantially perpendicularly to the substrate surface during no voltage application to the liquid crystal layer. In the FFS mode and the IPS mode, a counter electrode is disposed in the TFT substrate and liquid crystal molecules in the liquid crystal layer may be aligned substantially horizontally to the substrate surface during no voltage application to the liquid crystal layer. In the TN mode, a counter electrode is disposed in the CF substrate, and liquid crystal molecules in the liquid crystal layer may be spirally twisted from the TFT substrate toward the CF substrate by a rubbing treatment or another treatment. The alignment of the liquid crystal molecules is changed in response to the electric field generated in the liquid crystal layer by the voltage applied between the pixel electrodes and the counter electrode, so that the amount of light transmitted is controlled. Liquid crystal panels in a horizontal alignment mode such as the FFS mode or the IPS mode are suitable because the viewing angle in oblique directions is wide.

The liquid crystal panel may include alignment films, with one alignment film disposed between one of the substrates and the liquid crystal layer and another alignment film disposed between the other substrate and the liquid crystal layer. The alignment films are layers having undergone an alignment treatment for controlling the alignment of liquid crystal molecules. Examples of the material of the alignment films include polymers having a structure such as a polyimide, polyamic acid, or polysiloxane structure in their main chain. A photoalignment film material having a photoreactive site (functional group) in the main chain or a side chain is suitably used.

The liquid crystal molecules may have a positive or negative anisotropy of dielectric constant (Δε) defined by the following formula (L). In order to increase the contrast ratio, the liquid crystal molecules preferably have a negative Δε.

Δε=(dielectric constant in long axis direction)−(dielectric constant in short axis direction) (L)

### (Backlight)

The backlight 300 may be any backlight that can irradiate the liquid crystal panel 200 with light, such as a direct-lit type or an edge-lit type. The backlight 300 may further include a light guide plate and a reflector, for example.

The backlight 300 may be one including an illumination unit and a prism sheet disposed on the observation surface side of the illumination unit. The illumination unit emits light toward the liquid crystal panel 200 and may include, for example, a cold cathode fluorescent lamp (CCFL), a light emitting diode (LED), or a light guide plate.

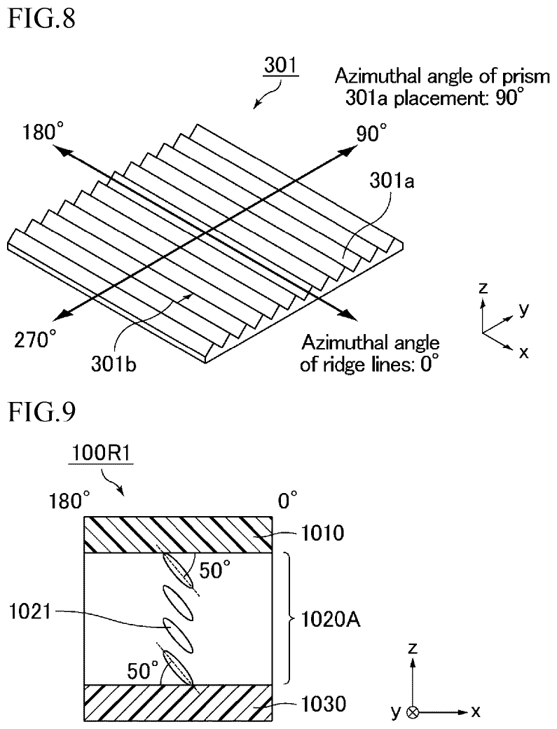

FIG. 8 is a perspective view of an example of a prism sheet included in a backlight. As shown in FIG. 8, a prism sheet 301 can be one including lines of prisms 301a that are parallel to each other on the surface closer to the observation surface side. The linearly continuous apexes of the bumps of the prism 301a are also referred to as ridge lines 301b of the prism sheet.

The ridge lines 301b of the prism sheet 301 are preferably arranged parallel to an azimuthal angle of 0°. Specifically, the ridge lines 301b are preferably at an azimuthal angle of 0°±3°. With the ridge lines 301b formed parallelly to an azimuthal angle of 0°, collection of light by the prism sheet at the azimuths corresponding to the left and right positions (azimuthal angle 0°-180°) is reduced as compared with collection of light by the prism sheet at azimuths corresponding to the top and bottom positions (azimuthal angle 90°-270°), so that the oblique luminance at the azimuths corresponding to the left and right positions can be increased to achieve a wide viewing angle. In this case, the prisms 301a perpendicular to the ridge lines 301b are arranged at an azimuthal angle of 90°. Such a structure is particularly suitable for OEM standards which require a wide luminance viewing angle at the azimuths corresponding to the left and right positions.

In a plan view, the absorption axis or reflection axis of the first polarizer 10, the absorption axis or reflection axis of the second polarizer 30, and the absorption axis or reflection axis of the third polarizer 50 are preferably parallel or perpendicular to the ridge lines 301b of the prism sheet 301. This structure allows more effective reduction or prevention of oblique light at azimuths corresponding to the top and bottom positions.

In a backlight including a prism sheet, some large-polar-angle light components of the light emitted from the light source and incident on the prism sheet may be scattered by the prisms (irregular structures) of the prism sheet, and the large-polar-angle light components may then be emitted from the prism sheet at a still larger polar angle without being collected to the front. Such a light component leaking at a large polar angle without being collected by the lens sheet is referred to as “side lobe light”. Side lobe light is essentially an unnecessary light component for image display and easily turns into stray light in the liquid crystal panel. Such stray light causes leakage of oblique light (large-polar-angle light) during black display, possibly being a factor of decreasing the contrast ratio during observation from an oblique direction.

The azimuth at which side lobe light is generated varies, for example, depending on the positions of the ridge lines of the prism sheet in the backlight. The studies made by the present inventors show that when a backlight is used that includes the prism sheet 301 with the ridge lines 301b being parallel to an azimuthal angle of 0° (azimuthal angle 0°-180°) or being parallel to an azimuthal angle of 90° (azimuthal angle 90°-270°), oblique side lobe light easily occurs at azimuths corresponding to the top and bottom positions (azimuthal angle 90°-270°). Thus, a backlight including the prism sheet 301 with the ridge lines 301b being parallel to an azimuthal angle of 0° (azimuthal angle 0°-180°) or parallel to an azimuthal angle of 90° (azimuthal angle 90°-270°) is combined with the optical element 100. This can make the azimuth and polar angle at which side lobe light occurs respectively match the azimuth and polar angle at which the transmittance can be reduced by the optical element 100, so that side lobe light can be effectively reduced or prevented.

The backlight may include a reflector on the back surface side of the illumination unit. Examples of the reflector include those usually used in the field of metal vapor-deposited films and display devices.

### EXAMPLES

The present invention will be described in more detail with reference to examples and comparative examples below, but the present invention is not limited only to these examples.

Simulations of the viewing angle in terms of transmittance and the viewing angle in terms of color transmittance (coloring) were conducted on optical elements of the examples and comparative examples using LCD Master available from Shintech Optics. The results are presented as contour diagrams. The dotted line circles in each contour diagram showing the viewing angle in terms of transmittance or the viewing angle in terms of color transmittance indicate polar angles of 20°, 40°, 60°, and 80° from the inside. The shades of the contour diagram showing the viewing angle in terms of transmittance correspond to the transmittances shown to the right in each figure. In the contour diagram showing the viewing angle in terms of color transmittance, the dark color portions indicate portions where coloring was observed.

The transmittances and coloring of optical elements of Comparative Examples 1 and 2 were examined, with each optical element used as a polarizing plate louver including a single retardation layer, which corresponds to conventional technology.

### Comparative Example 1

FIG. 9 is a schematic cross-sectional view of an optical element of Comparative Example 1. As shown in FIG. 9, an optical element 100R1 of Comparative Example 1 included a first polarizer 1010, a retardation layer 1020A, and a second polarizer 1030 in this order. The first polarizer 1010 and the second polarizer 1030 were single-layer absorptive linear polarizers. As shown in FIG. 9, anisotropic molecules 1021 contained in the retardation layer 1020A were uniformly oriented in the lower-right direction from the front polarizing plate (first polarizer 1010) toward the back polarizing plate (second polarizer 1030) at a tilt angle of 50°. The in-plane retardation of the retardation layer 1020A was 220 nm.

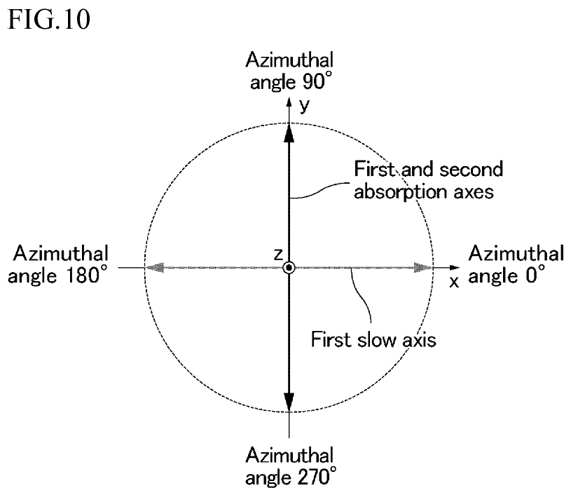

FIG. 10 shows axis azimuths of components of the optical element of Comparative Example 1. As shown in FIG. 10, in a plan view, the absorption axis (first absorption axis) of the first polarizer and the absorption axis (second absorption axis) of the second polarizer were disposed parallel to the azimuthal angle 90°-270° such that they would be parallel to each other. The slow axis of the retardation layer 1020A was perpendicular to the first absorption axis. The alignment azimuth of the anisotropic molecules 1021 in the retardation layer 1020A was set to an azimuthal angle of 180°.

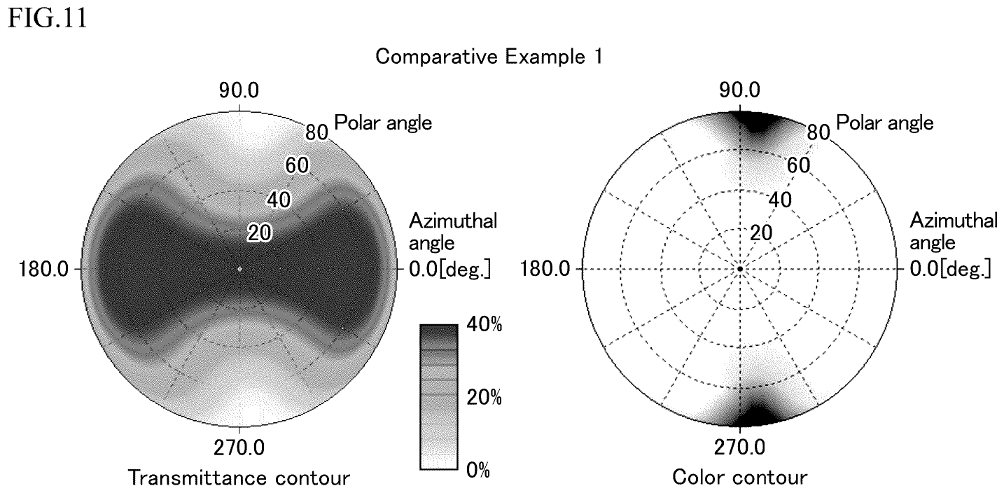

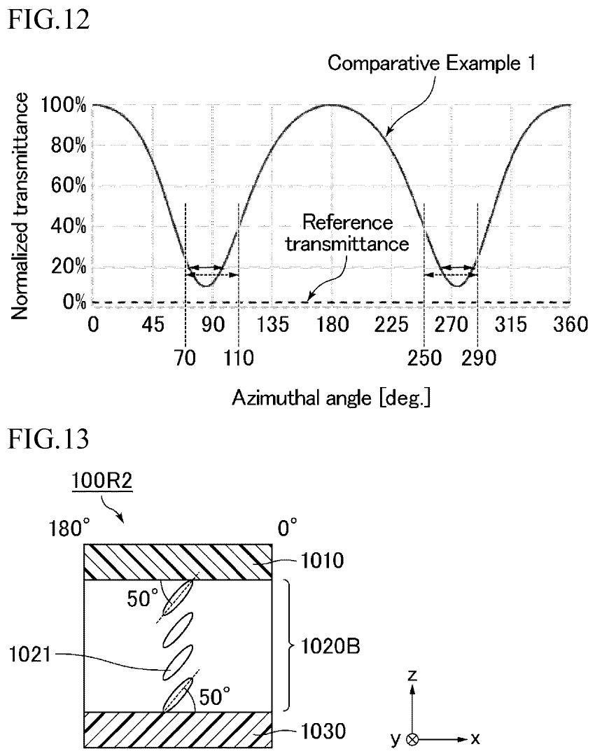

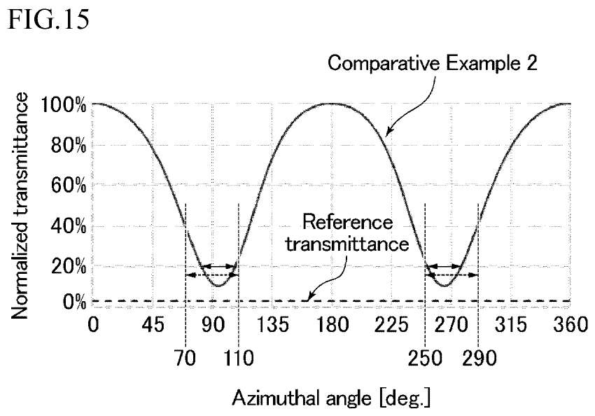

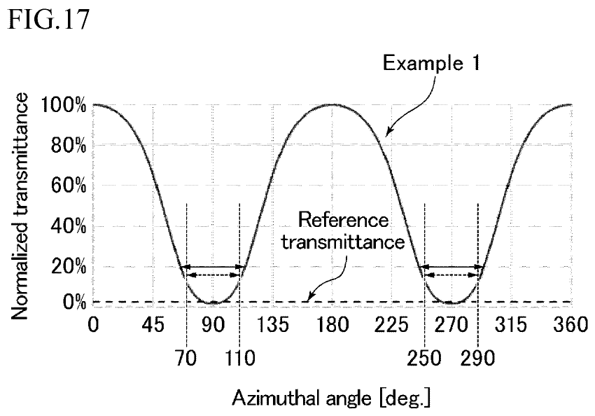

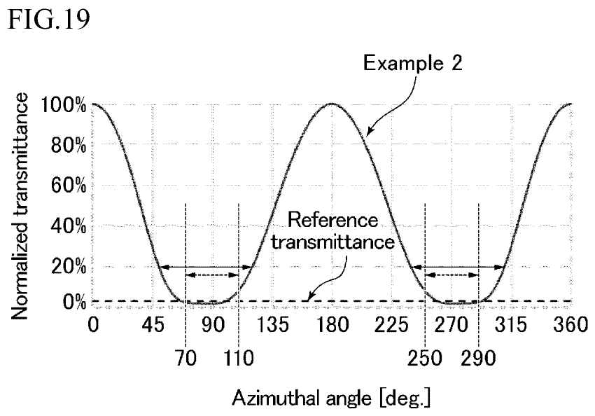

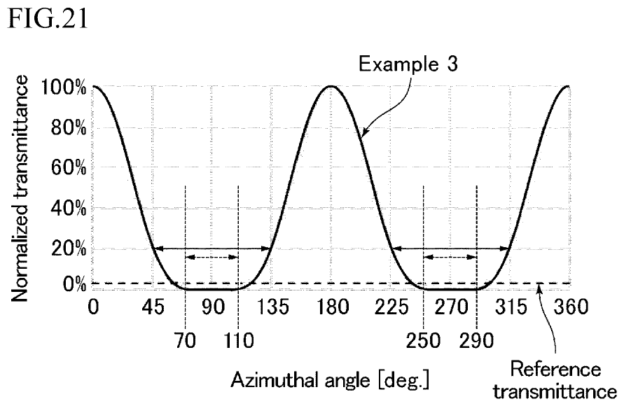

FIG. 11 shows simulation results showing the viewing angle in terms of transmittance and coloring of the optical element of Comparative Example 1. FIG. 12 is a graph showing the normalized transmittance of the optical element of Comparative Example 1, measured at azimuthal angles from 0° to 360° and a polar angle of 60°. In FIG. 12 and the later-described FIG. 15, FIG. 17, FIG. 19, and FIG. 21, the vertical axis of each graph represents the normalized transmittance, based on the simulation results of the viewing angle in terms of transmittance in the corresponding example or comparative example, with the maximum transmittance at a polar angle of 60° set to 100%. In the graph in each figure, the normalized transmittance at azimuthal angles of 90° and 270° at a polar angle of 60° is preferably 2% (which corresponds to the reference transmittance in each graph) or lower. Additionally, the normalized transmittance is preferably 20% or lower within the azimuthal angle ranges of 90°±20° and 270°±20° at a polar angle of 60°. In each graph, the ranges where the azimuthal angle is 90°±20° or 270°±20° and the normalized transmittance is 20% are indicated by dotted double-headed arrows. Also, in each of the examples and comparative examples, lines each obtained by connecting the points where the azimuthal angle falls within the range of 90°±20° or 270°±20° and the normalized transmittance is 20% are indicated by solid double-headed arrows. When the width of a solid double-headed arrow is wider than the width of the corresponding dotted double-headed arrow, the normalized transmittance is 20% or lower at an azimuthal angle within the range of 90°±20° or 270°±20° at a polar angle of 60°.

In Comparative Example 1, the light-shielding effect was achieved at azimuths corresponding to the top and bottom positions as shown in the simulation results of the viewing angle in terms of transmittance in FIG. 11. However, as shown in FIG. 12, the light-shielding ranges, where the azimuthal angle is 90°±20° or 270°±20° and the normalized transmittance is 20% or lower, were narrow and the minimum normalized transmittance was higher than the reference transmittance, resulting in a weak light-shielding effect. Additionally, the azimuthal angles where the normalized transmittance reached its minimum were approximately 80° and 280°, slightly offset from the azimuths corresponding to the top and bottom positions (azimuthal angle of 90° and azimuthal angle of 270°).

### Comparative Example 2

FIG. 13 is a schematic cross-sectional view of an optical element of Comparative Example 2. An optical element 100R2 of Comparative Example 2 had the same structure as in Comparative Example 1, except that the alignment azimuth of the anisotropic molecules was changed to 0°. As shown in FIG. 13, the anisotropic molecules 1021 contained in a retardation layer 1020B were uniformly oriented in the lower-left direction from the front polarizing plate (first polarizer 1010) toward the back polarizing plate (second polarizer 1030) at a tilt angle of 50°. The alignment azimuth of the anisotropic molecules in the retardation layer 1020B was set to an azimuthal angle of 0°.

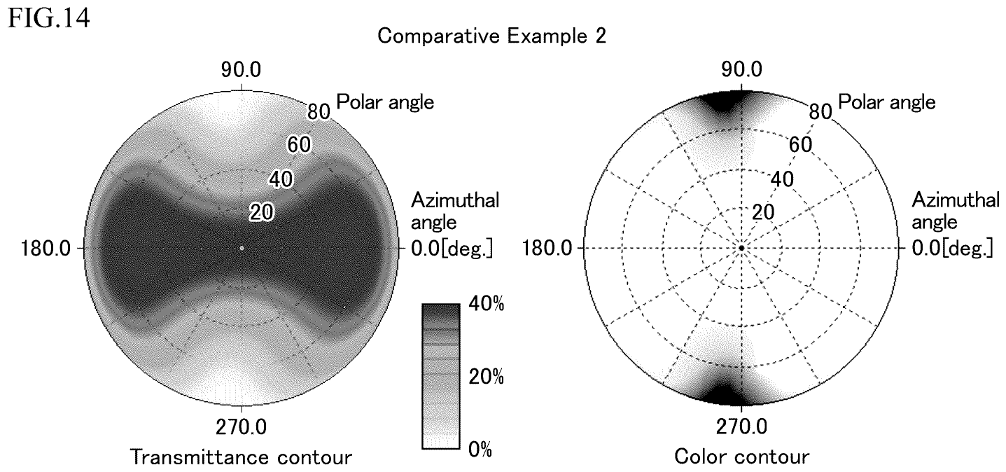

FIG. 14 shows simulation results showing the viewing angle in terms of transmittance and coloring of the optical element of Comparative Example 2. FIG. 15 is a graph showing the normalized transmittance of the optical element of Comparative Example 2, measured at azimuthal angles from 0° to 360° and a polar angle of 60°. In Comparative Example 2, the light-shielding effect was achieved at azimuths corresponding to the top and bottom positions as shown in the simulation results of the viewing angle in terms of transmittance in FIG. 14. However, as shown in FIG. 15, the light-shielding ranges, where the azimuthal angle is 90°±20° or 270°±20° and the normalized transmittance is 20% or lower, were narrow and the minimum normalized transmittance was higher than the reference transmittance, resulting in a weak light-shielding effect. Additionally, the azimuthal angles where the normalized transmittance reached its minimum were approximately 100° and 260°, slightly offset from the azimuths corresponding to the top and bottom positions (azimuthal angle of 90° and azimuthal angle of 270°).

### Example 1

An optical element of Example 1 is a specific example of the optical element of Embodiment 1 and has the structure shown in FIG. 2 to FIG. 4. As shown in FIG. 2, the optical element of Example 1 included, in order from the observation surface side, the first polarizer 10, the first retardation layer 20, the second polarizer 30, the second retardation layer 40, and the third polarizer 50. The first polarizer 10, the second polarizer 30, and the third polarizer 50 were single-layer absorptive linear polarizers.

The tilt angle of the first anisotropic molecules 21 contained in the first retardation layer 20 and tilt angle of the second anisotropic molecules 41 contained in the second retardation layer 40 were both 50°. In other words, the tilt angle θ₁₋₁ of the first anisotropic molecules included in the first retardation layer 20 and located near the first polarizer 10, the tilt angle θ₁₋₂ of the first anisotropic molecules included in the first retardation layer 20 and located near the second polarizer 30, the tilt angle θ₂₋₁ of the second anisotropic molecules included in the second retardation layer 40 and located near the second polarizer 30, and the tilt angle θ₂₋₂ of the second anisotropic molecules included in the second retardation layer 40 and located near the third polarizer 50 were all 50°.

As shown in FIG. 3, the alignment azimuth of the first anisotropic molecules 21 was set to an azimuthal angle of 0°, and the alignment azimuth of the second anisotropic molecules 41 was set to an azimuthal angle of 180°. The in-plane retardations of the first retardation layer 20 and the second retardation layer 40 were both 220 nm.

As shown in FIG. 4, the absorption axes of the first to third polarizers 10, 20, and 50 were parallel to one another, and the slow axes of the first and second retardation layers were parallel to each other. The absorption axes of the first to third polarizers 10, 20, and 50 were perpendicular to the slow axes of the first and second retardation layers.

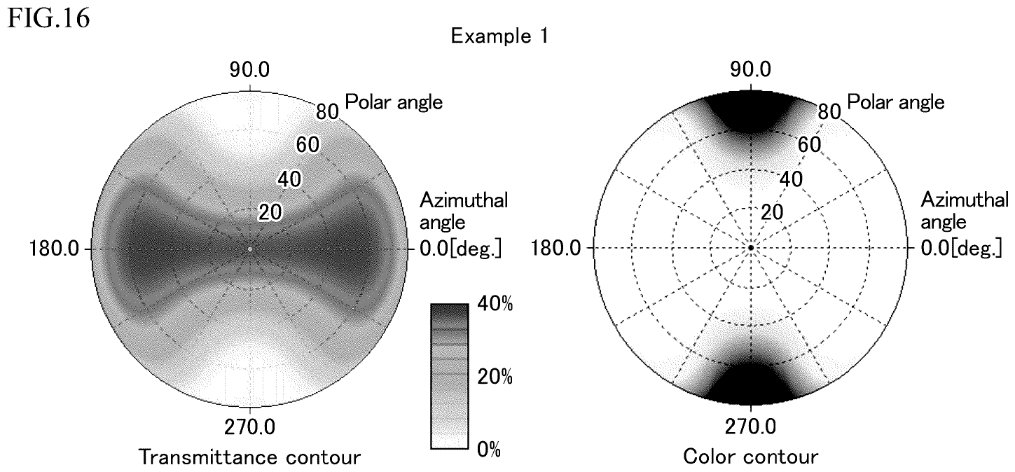

FIG. 16 shows simulation results showing the viewing angle in terms of transmittance and coloring of an optical element of Example 1. The simulation results of the viewing angle in terms of transmittance in FIG. 16 demonstrate that the optical element of Example 1 reduced light leakage at azimuths corresponding to the top and bottom positions, reduced coloring during observation from an oblique direction, and exhibited a horizontally symmetrical light-shielding range. Combination use of two retardation layers with opposite alignment azimuths of anisotropic molecules was confirmed to successfully make the light-shielding range horizontally symmetrical.

FIG. 17 is a graph showing the normalized transmittance of the optical element of Example 1, measured at azimuthal angles from 0° to 360° and a polar angle of 60°. As shown in FIG. 17, the azimuthal angles where the normalized transmittance reached its minimum at a polar angle of 60° were those corresponding to the top and bottom positions (azimuthal angle of 90° and azimuthal angle of 270°), and the minimum normalized transmittance was less than or equal to 0.2%, which served as the reference transmittance. In FIG. 17, the widths of the solid double-headed arrows were greater than the widths of the corresponding dotted double-headed arrows, and the normalized transmittance was 20% or lower at azimuthal angles within the ranges of 90°±20° and 270°±20°.

### Example 2

An optical element of Example 2 is a specific example of the optical element of Embodiment 2 and has the structure shown in FIG. 3 to FIG. 5. As shown in FIG. 5, the optical element of Example 2 included, in order from the observation surface side, the first polarizer 10, the negative C plate 60, the first retardation layer 20, the second polarizer 30, the second retardation layer 40, and the third polarizer 50. The structure in Example 2 was the same as in Example 1, except that the negative C plate 60 was included. The retardation of the negative C plate 60 in the thickness direction was 300 nm.

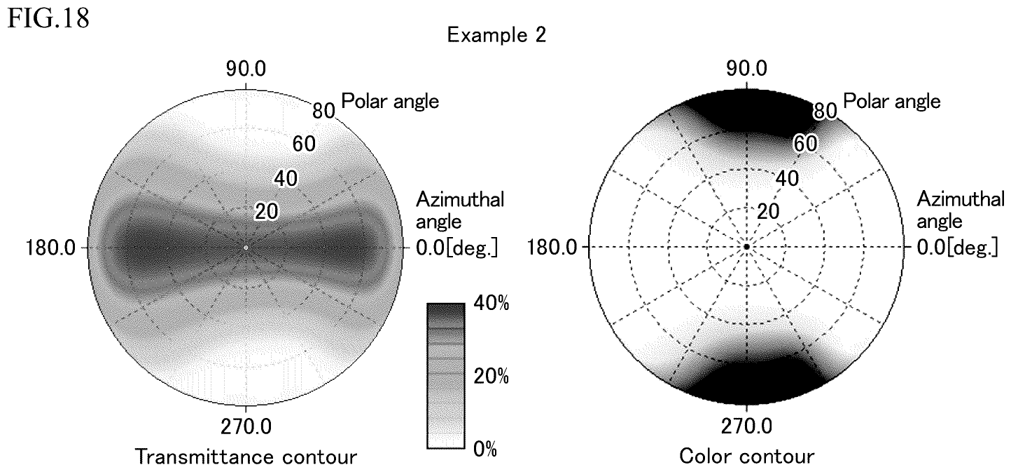

FIG. 18 shows simulation results showing the viewing angle in terms of transmittance and coloring of an optical element of Example 2. FIG. 19 is a graph showing the normalized transmittance of the optical element of Example 2, measured at azimuthal angles from 0° to 360° and a polar angle of 60°. The simulation results of the viewing angle in terms of transmittance in FIG. 18 demonstrate that the light-shielding range in Example 2 was wider than in Example 1. In FIG. 19, the widths of the solid double-headed arrows were greater than the widths of the corresponding dotted double-headed arrows, and the ranges where the azimuthal angle was 90°±20° or 270°±20° and the normalized transmittance was 20% or lower were wider than the ranges in Example 1. This result confirmed that use of the negative C plate 60 enhanced the light-shielding effect.

### Example 3

An optical element of Example 3 is a specific example of the optical element of Embodiment 3 and has the structure shown in FIG. 3, FIG. 4, and FIG. 6. The structure in Example 3 was the same as in Example 2, except that the second negative C plate 70 was added, the tilt angles of the first and second anisotropic molecules were changed, and the in-plane retardations of the first and second retardation layers were changed.

As shown in FIG. 6, the optical element of Example 3 included, in order from the observation surface side, the first polarizer 10, the first negative C plate 60, the first retardation layer 20, the second polarizer 30, the second negative C plate 70, the second retardation layer 40, and the third polarizer 50. The retardations of the first negative C plate 60 and the second negative C plate 70 in the thickness direction were both 300 nm.

The tilt angle of the first anisotropic molecules 21 and the tilt angle of the second anisotropic molecules 41 were both set to 54°. In other words, θ₁₋₁, θ₁₋₂, θ₂₋₁, and θ₂₋₂ were all 54°. The in-plane retardations of the first retardation layer 20 and the second retardation layer 40 were 275 nm.

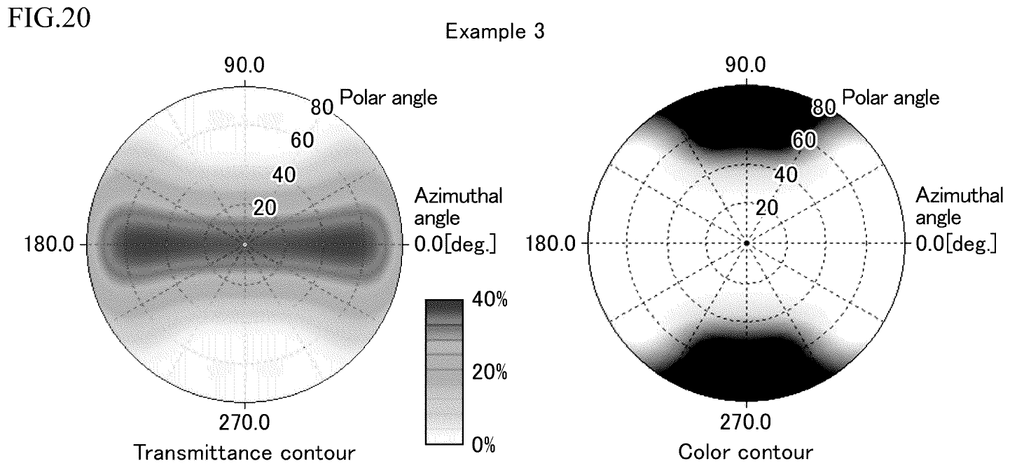

FIG. 20 shows simulation results showing the viewing angle in terms of transmittance and coloring of an optical element of Example 3. FIG. 21 is a graph showing the normalized transmittance of the optical element of Example 3, measured at azimuthal angles from 0° to 360° and a polar angle of 60°. The simulation results of the viewing angle in terms of transmittance in FIG. 20 demonstrate that the light-shielding range in Example 3 was even wider than in Example 2 and the light-shielding range was horizontally symmetrical. Also, in FIG. 21, the widths of the solid double-headed arrows were greater than the widths of the corresponding dotted double-headed arrows, and the range where the azimuthal angle was 90°±20° or 270°±20° and the normalized transmittance was 20% or lower was even wider than in Example 2. This result confirmed that use of two negative C plates further enhanced the light-shielding effect.

### Examples 4 to 8

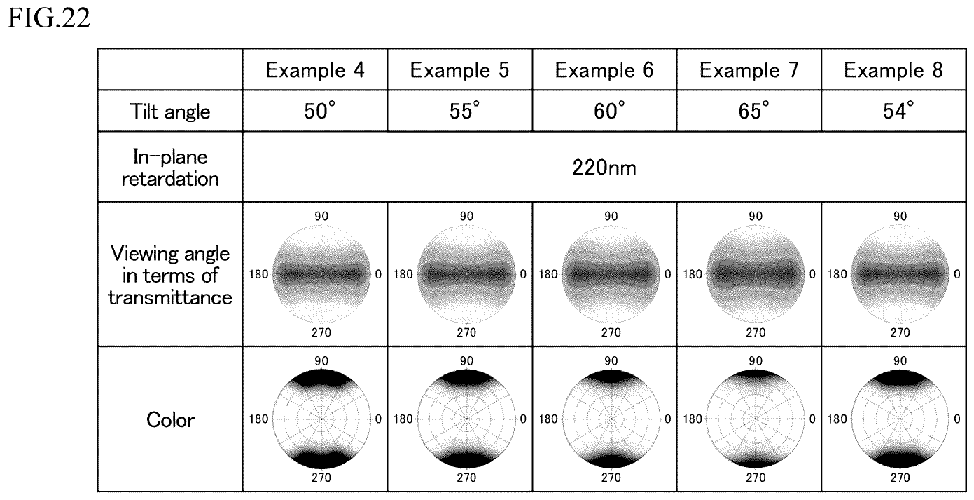

In Examples 4 to 8, the in-plane retardations of the first and second retardation layers were fixed and the tilt angles of the first and second anisotropic molecules were varied to examine the light-shielding performance of the optical element. The optical elements of Examples 4 to 8 had the same structure as in Example 3, except that the in-plane retardations of the first and second retardation layers were changed to 220 nm and the tilt angles of the first and second anisotropic molecules were changed as shown in FIG. 22. FIG. 22 is a table summarizing the simulation results showing the viewing angles in terms of transmittance and coloring of the optical elements of Examples 4 to 8.

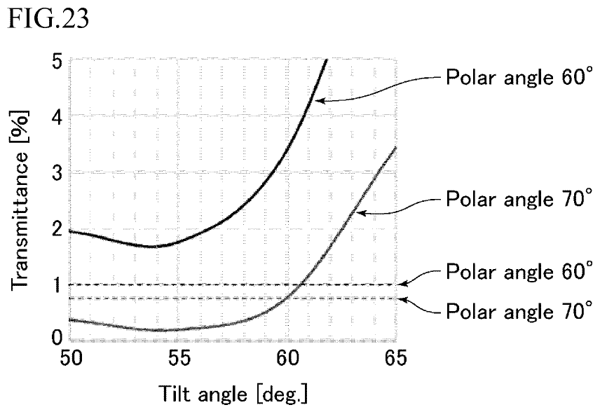

The transmittances of the optical elements at polar angles of 60° and 70° when the tilt angles were varied from 50° to 65° are summarized in Table 1 and the graph in FIG. 23, based on the simulation results of the viewing angle in terms of transmittance in FIG. 22. FIG. 23 is a graph showing the transmittance of an optical element measured at polar angles of 60° and 70° when the tilt angles of anisotropic molecules were varied. The transmittances of the optical elements at polar angles of 60° and 70° shown in Table 1 and FIG. 23 are each the average of the transmittances at azimuths corresponding to the top and bottom positions (azimuthal angles of 90° and 270°).

TABLE 1

| | Tilt | In-plane | Transmittance at | Transmittance at |
|---|---|---|---|---|
| | angle | retardation | polar angle 60° | polar angle 70° |
| | [deg.] | (nm) | [%] | [%] |
| Example 4 | 50 | 220 | 1.94 | 0.38 |
| Example 5 | 55 | | 1.74 | 0.2 |
| Example 6 | 60 | | 3.4 | 0.77 |
| Example 7 | 65 | | 8.58 | 3.43 |
| Example 8 | 54 | | 1.54 | 0.12 |

As shown in FIG. 23, both at polar angles of 60° and 70°, the transmittance reached its minimum when the tilt angles of the first and second anisotropic molecules were approximately 54°. When the target transmittance at a polar angle of 60° was set to 0.95% and the target transmittance at a polar angle of 70° was set to 0.75%, the transmittance at a polar angle of 70° was 0.12% at tilt angles of the first and second anisotropic molecules of 54° as shown in Table 1. This value was significantly lower than the target value.

### Examples 9 to 12

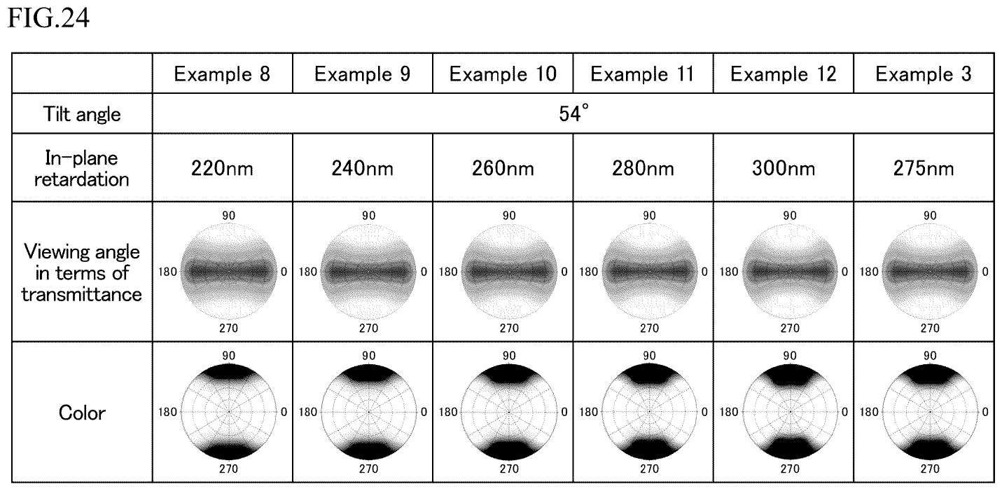

In Examples 9 to 12 as well as Example 3 and Example 8, the tilt angles of the first and second anisotropic molecules were fixed and the in-plane retardations of the first and second retardation layers were varied to examine the light-shielding performance of the optical element. The optical elements of Examples 9 to 12 had the same structure as in Example 3, except that the tilt angles of the first and second anisotropic molecules were changed to 54° and the in-plane retardations of the first and second retardation layers were changed as shown in FIG. 24. FIG. 24 is a table summarizing the simulation results showing the viewing angles in terms of transmittance and coloring of the optical elements of Examples 3 and 8 to 12.

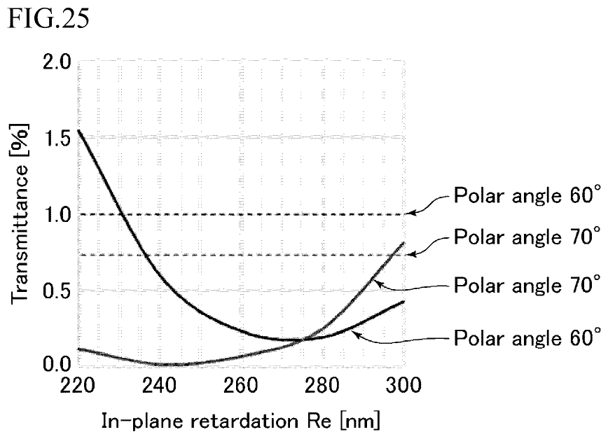

The transmittances of the optical elements at polar angles of 60° and 70° when the in-plane retardations of the first and second retardation layers were varied from 220 nm to 300 nm are summarized in Table 2 and the graph in FIG. 25, based on the simulation results of the viewing angle in terms of transmittance in FIG. 24. FIG. 25 is a graph showing the transmittance of an optical element measured at polar angles of 60° and 70° when the in-plane retardations of retardation layers were varied. The transmittances of the optical elements at polar angles of 60° and 70° shown in Table 2 and FIG. 25 are each the average of the values at azimuths corresponding to the top and bottom positions (azimuthal angles of 90° and 270°).

TABLE 2

| | Tilt | In-plane | Transmittance at | Transmittance at |
|---|---|---|---|---|
| | angle | retardation | polar angle 60° | polar angle 70° |
| | [deg.] | (nm) | [%] | [%] |
| Example 8 | 54 | 220 | 1.54 | 0.12 |
| Example 9 | | 240 | 0.6 | 0.02 |
| Example 10 | | 260 | 0.24 | 0.07 |
| Example 11 | | 280 | 0.2 | 0.26 |
| Example 12 | | 300 | 0.43 | 0.81 |
| Example 3 | | 275 | 0.2 | 0.2 |

Both at polar angles of 60° and 70° within the range where the in-plane retardations of the first and second retardation layers were from about 240 nm to 295 nm, the transmittances at a polar angle of 60° and a polar angle of 70° were respectively lower than the target transmittances, 0.95% and 0.75%. Based on a comprehensive evaluation of the transmittances at polar angles of 60° and 70°, the results indicate that the optimal transmittance was achieved when the in-plane retardations of the first and second retardation layers were 275 nm. When the in-plane retardations of the first and second retardation layers were 275 nm, the transmittances at azimuths corresponding to the top and bottom positions were 0.2% at a polar angle of 60° and 0.2% at a polar angle of 70°, which were significantly lower than the respective target values.

The above results suggest that the optimal conditions for achieving a favorable optical element are a structure corresponding to Embodiment 3, tilt angles of 54° for the first and second anisotropic molecules, and in-plane retardations of 275 nm for the first and second retardation layers.

What is claimed is:

1. An optical element comprising, in the following order:
a first polarizer;
a first retardation layer containing first anisotropic molecules;
a second polarizer;
a second retardation layer containing second anisotropic molecules; and
a third polarizer,
wherein in a plan view, an absorption axis or reflection axis of the first polarizer, an absorption axis or reflection axis of the second polarizer, and an absorption axis or reflection axis of the third polarizer are parallel to one another,
in a plan view, a slow axis of the first retardation layer and a slow axis of the second retardation layer are parallel to each other,
the absorption axis or reflection axis of the first polarizer is perpendicular to the slow axis of the first retardation layer,
a tilt angle of the first anisotropic molecules is constant in a thickness direction of the first retardation layer,
a tilt angle of the second anisotropic molecules is constant in a thickness direction of the second retardation layer,
an alignment azimuth of the first anisotropic molecules is defined as an azimuth obtained by projecting a direction along long axes of the first anisotropic molecules from a side of the first retardation layer closer to the second polarizer toward a side of the first retardation layer closer to the first polarizer onto a surface of the first retardation layer adjacent to the first polarizer,
an alignment azimuth of the second anisotropic molecules is defined as an azimuth obtained by projecting a direction along long axes of the second anisotropic molecules from a side of the second retardation layer closer to the third polarizer toward a side of the second retardation layer closer to the second polarizer onto a surface of the second retardation layer adjacent to the second polarizer, and
in a plan view, the alignment azimuth of the first anisotropic molecules and the alignment azimuth of the second anisotropic molecules are oriented in directions opposite to each other.

2. The optical element according to claim 1,
wherein a negative C plate is disposed at least one of between the first polarizer and the first retardation layer and between the second polarizer and the second retardation layer.

3. The optical element according to claim 1,
wherein negative C plates are disposed, with one negative C plate positioned between the first polarizer and the first retardation layer and another negative C plate positioned between the second polarizer and the second retardation layer.

4. The optical element according to claim 2,
wherein a retardation of the negative C plate in a thickness direction is 250 nm or more and 320 nm or less.

5. The optical element according to claim 1,
wherein a tilt angle of the first anisotropic molecules is substantially the same as a tilt angle of the second anisotropic molecules.

6. The optical element according to claim 1,
wherein the first polarizer is an absorptive polarizer or a laminate of an absorptive polarizer and a reflective polarizer,
the second polarizer is an absorptive polarizer or a reflective polarizer, and
the third polarizer is a reflective polarizer or a laminate of an absorptive polarizer and a reflective polarizer.

7. A display device comprising, in the following order:
a liquid crystal panel;
the optical element according to claim 1; and
a backlight,
the optical element being disposed with the first polarizer being adjacent to the liquid crystal panel.
